(19) United States
(12) Patent Application Publication
(10) Pub. No.: US 2016/0104246 A1
(43) Pub. Date: Apr. 14, 2016

(54) SYSTEM FOR DYNAMICALLY CALCULATING CLAIM ALLOCATIONS

(71) Applicant: Hartford Fire Insurance Company, Hartford, CT (US)

(72) Inventors: Kelly J. McLaughlin, Cobalt, CT (US); Thomas William McClure, Duxbury, MA (US); Kathleen H. Galia, South Seaville, NJ (US)

(21) Appl. No.: 14/510,271

(22) Filed: Oct. 9, 2014

(51) Int. Cl. G06Q 40/08; G06Q 10/10

(52) U.S. Cl. CPC G06Q 40/08; G06Q 10/1057

(57) ABSTRACT

According to some embodiments, systems, methods, apparatus, computer program code and means may receive information about a party potentially entitled to receive a stream of future payments in connection with an insurance policy, such as a workers' compensation insurance policy, between an insurer and an insured. A computer processor of a present value calculation platform may automatically calculate a nominal value associated with the stream of future payments based at least in part on the information about the party potentially entitled to receive the stream of future payments and insurance risk factor data. A discount value may also be automatically calculated, such that reduction of the nominal value by the discount value results in a present value of the stream of future payments. A portion of the discount value to be allocated to the insured may be automatically determined, and an indication of that portion may be transmitted.

### FIELD

The present invention relates to computer systems and more particularly to computer systems that facilitate a dynamic calculation of a claim allocation amount between parties.

### BACKGROUND

In some cases, an insurer and an insured are associated with a party who is potentially entitled to receive a stream of future payments. For example, an insured may purchase a workers' compensation insurance policy from an insurer, and both the insured and insurer may have obligations with respect to monthly payments that must be provided to a worker (who was injured while he or she was working) over the next twenty years. Depending on the terms and conditions of the particular insurance policy, the insured may be responsible for a portion of the stream of future payments while the insurer is responsible for the remaining value. Note that the insurer may be responsible for the payments to a worker, and may obtain reimbursement from the insured up to a value of a deductible amount associated with the insurance policy.

The exact value of the stream of future payments may be uncertain, such as when the stream is dependent on the age of the party receiving the payments, whether the injury improves or becomes worse over time, etc. Moreover, converting this stream of future payments into a single, present day payment may have different financial implications for the insurer and the insured. For example, the insurer might prefer a single, present day payment that reduces the uncertainty and risks associated with future payments while the insured might be a business more concerned about the accounting impact of a single present day payment (e.g., because the entire cost of the obligation might occur in a single financial year as opposed to being spread out over many financial years). As a result, allocating amounts in view of the various aspects of converting a stream of future payments into a single, present day payment can be a complicated task. Moreover, typical methods of calculating a settlement value between a claimant and the insurance carrier may rely upon a calculation of a net present value of an expected payment stream, while the deductible calculation between the insured and the insurer may be calculated in absolute terms (e.g., without providing any credit for the net present value reduction).

It would therefore be desirable to provide systems and methods to facilitate a calculation of an allocation amount between an insurer and an insured that provides credit for the net present value of an estimated stream of payments in an automated, efficient, and accurate manner.

### SUMMARY

According to some embodiments, systems, methods, apparatus, computer program code and means may calculation of an allocation amount between an insurer and an insured that provides credit for the net present value of an estimated stream of payments. In some embodiments, systems, methods, apparatus, computer program code and means may promote the calculation of an allocation amount associated with an insurance product, such as a workers' compensation insurance policy. According to some embodiments, information may be received about a party potentially entitled to receive a stream of future payments in connection with an insurance policy between an insurer and an insured. A computer processor of a present value calculation platform may automatically calculate a nominal value associated with the stream of future payments based at least in part on the information about the party potentially entitled to receive the stream of future payments and insurance risk factor data. A discount value may also be automatically calculated, such that reduction of the nominal value by the discount value results in a present value of the stream of future payments. A portion of the discount value to be allocated to the insured may be automatically determined, and an indication of that portion may be transmitted.

A technical effect of some embodiments of the invention is an improved and computerized method to facilitate a calculation of an allocation amount between an insurer and an insured that provides credit for the net present value of an estimated stream of payments. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates relationships between parties associated with an insurance policy.

FIG. 3 is a flow diagram of a process according to some embodiments.

FIG. 4 illustrates categorized and aggregated historical claim cost data according to some embodiments.

FIG. 5 illustrates categorized and aggregated historical claim count data according to some embodiments.

FIG. 6 is a flow diagram of a process according to some embodiments.

FIG. 7 is an outward view of a representative interface to receive current claim data according to some embodiments.

FIG. 8 is a graphical representation of a graphical representation of an estimated cost and a likelihood associated with each of a plurality of outcome scenarios for a first claim category according to some embodiments.

FIG. 9 illustrates categorized and aggregated historical claim count data according to some embodiments.

FIG. 10 illustrates a method that might be performed in accordance with some embodiments.

FIG. 11 is an example of an allocation user interface associated with a first example in accordance with some embodiments.

FIG. 12 is a bar graph illustrating difference between various types of allocation schemes in accordance with some embodiments.

FIG. 13 is an example of an input output user interface associated with a first example according to some embodiments.

FIG. 14 is an example of a claim projection user interface associated with a first example in accordance with some embodiments.

FIG. 15 is an example of a male mortality user interface in accordance with some embodiments.

FIG. 16 is an example of a female mortality user interface according to some embodiments.

FIG. 17 is an example of a state-by-state interest rate user interface in accordance with some embodiments.

FIG. 18 is block diagram of a present value tool or platform according to some embodiments of the present invention.

FIG. 19 is a tabular portion of a parameter database according to some embodiments.

FIG. 20 illustrates a present value calculation method that might be performed in accordance with some embodiments.

FIG. 21 is an example of an allocation user interface associated with a second example in accordance with some embodiments.

FIG. 22 is an example of an allocation user interface associated with a third example in accordance with some embodiments.

FIG. 23 illustrates a handheld tablet results display according to some embodiments described herein.

### DETAILED DESCRIPTION

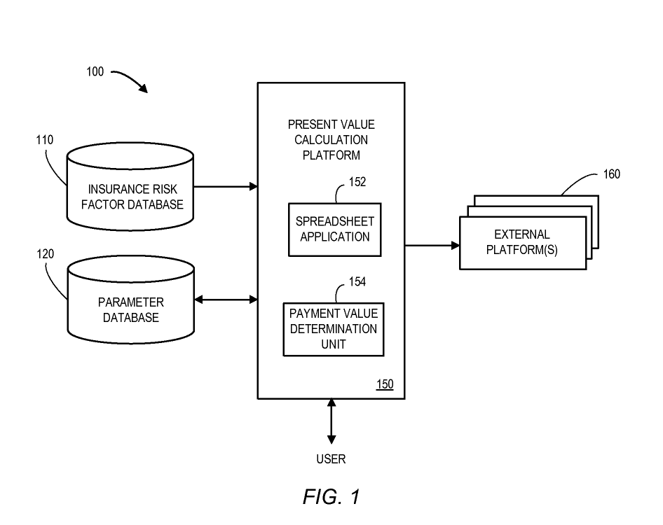

Some embodiments described herein may facilitate a calculation of an allocation amount between an insurer and an insured that provides credit for the net present value of an estimated stream of payments. Further, some embodiments may provide a mechanism that automates a user interface that might be used, for example, by an insurance claim handler to determine an allocation amount associated with a workers' compensation insurance claim. FIG. 1 is block diagram of a system 100 according to some embodiments of the present invention. In particular, the system 100 includes a present value calculation platform 150 that receives information from an insurance risk factor database 110 (e.g., which may store mortality information about various genders, ages, etc.) and stores information into and receives information from a parameter database 120 (e.g., associated with a particular insurance claim being examined).

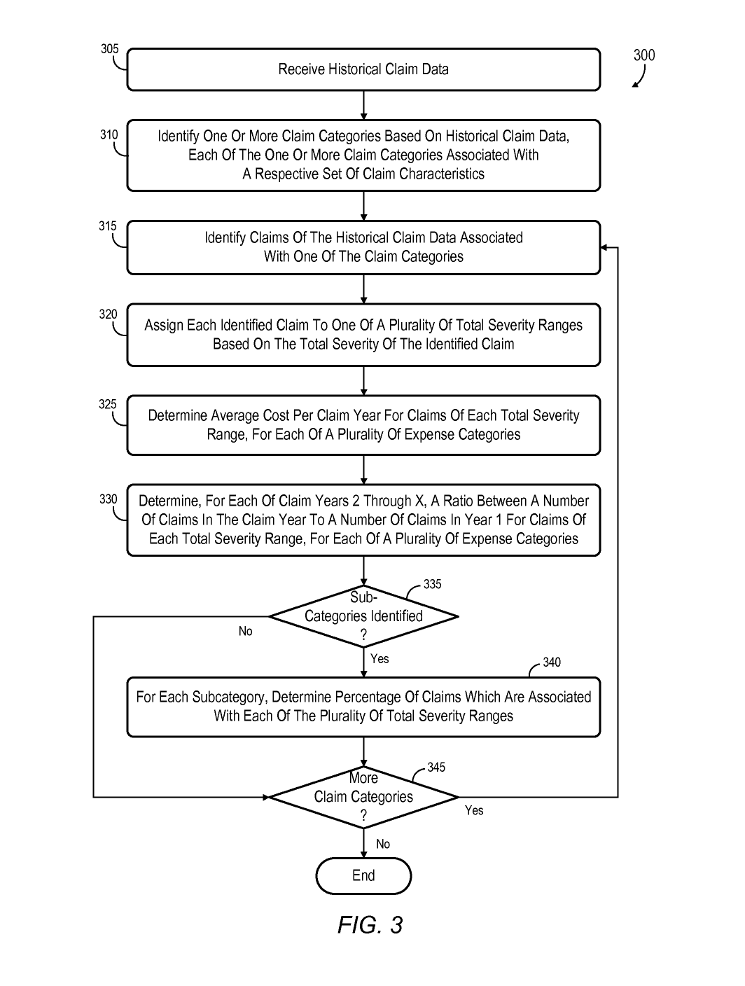

The present value calculation platform 150 might be, for example, associated with a Personal Computers (PC), a spreadsheet application 152 such as the EXCEL® spreadsheet application available from MICROSOFT CORPORATION® (e.g., including spreadsheet workbooks and/or templates), a laptop computer, an enterprise server, a server farm, and/or a database or similar storage devices. The present value calculation platform 150 may, according to some embodiments, be associated with an insurance provider. According to some embodiments, the present value calculation platform further includes a payment value determination unit 154 to automatically determine payment values associated with a stream of future payments based at least in part on injury information (e.g., as described herein with respect to FIGS. 3 through 9).

According to some embodiments, an “automated” present value calculation platform 150 may help promote the calculation and transmission of an allocation amount. For example, the present value calculation platform 150 may automatically output an appropriate allocation amount via a graphical user interface display. As used herein, the terms “automated” and “automatically” may refer to, for example, actions that can be performed with little (or no) intervention by a human. Moreover, a present value calculation platform may “dynamically” calculate values by automatically updating outputs in substantially real time.

As used herein, devices, including those associated with the present value calculation platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The present value calculation platform 150 may store information into and/or retrieve information from the databases 110, 120. The databases 110, 120 might be associated with, for example, an insurance provider or insurer. The databases 110, 120 might be locally stored or reside remote from the present value calculation platform 150. According to some embodiments, the present value calculation platform 150 communicates information about appropriate an allocation amount, such as by transmitting an electronic file or signal to an external platform 160 associated with a claim handler, an insurance agent or analyst platform, an email server, a workflow management system, etc.

Although a single present value calculation platform 150 is shown in FIG. 1, any number of such devices may be included. Moreover, various devices described herein might be combined according to embodiments of the present invention. For example, in some embodiments, the present value calculation platform 150 and databases 110, 120 might be co-located and/or may comprise a single apparatus.

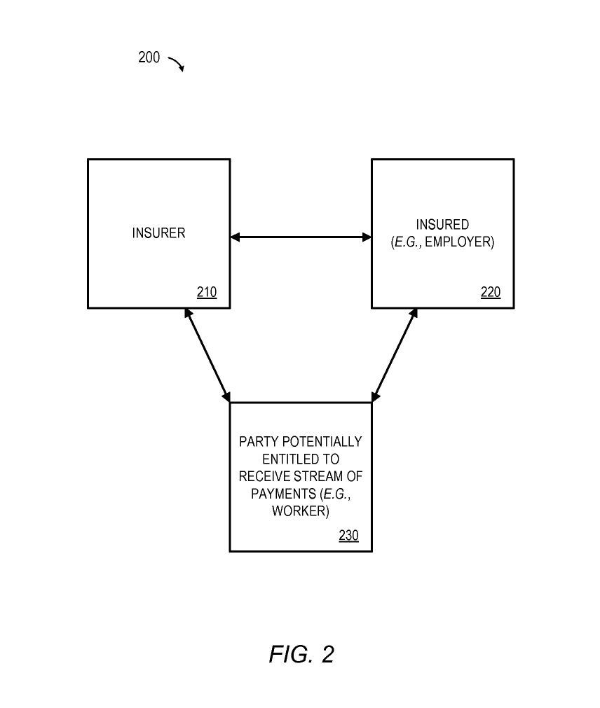

A user may input information into and receive information from the present value calculation platform 150. According to some embodiments, the user is associated with an insurance policy. FIG. 2 illustrates relationships 200 between an insurer 210 and an insured 220. By way of example, the insured 220 might purchase a workers' compensation insurance policy from the insurer 210. According to some embodiments, another party may act as a Third Party Administrator (“TPA”) by handling insurance claims as they arise under the policy. In some cases, the insurer 210 and an insured 220 are associated with a party 230 who is potentially entitled to receive a stream of future payments. For example, both the insured 220 and insurer 210 may have obligations with respect to monthly payments that must be provided to a worker (who was injured while he or she was working) for the rest of the worker's life. Depending on the terms and conditions of the particular insurance policy, the insured 220 may be responsible for a portion of the stream of future payments (e.g., up to a deductible amount) while the insurer 210 is responsible for the remaining value.

The exact value of the stream of future payments may be uncertain, such as when the stream depends on the age of the party 230 receiving the payments, whether the injury improves or becomes worse over time, etc. Moreover, converting this stream of future payments into a single, present day payment may have different financial implications for the insurer 210 and the insured 220. For example, the insurer 210 might prefer a single, present day payment that reduces the uncertainty and risks associated with future payments while the insured 220 might be a business more concerned about the accounting impact of a single present day payment (e.g., because the entire cost of the obligation might occur in a single financial year as opposed to being spread out over many financial years). As a result, allocating amounts in view of the various aspects of converting a stream of future payments into a single, present day payment can be a complicated task.

According to some embodiments, information about a stream of future payments may need to be established (e.g., payment values may need to be determined). In some cases, an operator or claim handler might provide these amounts (e.g., dollar values) and/or the timing of the stream of future payments. According to other embodiments, at least some of the information about the stream of future payments may be calculated based on historical claim data. For example, some embodiments may use one or more computer systems to categorize and aggregate historical claim data and/or evaluation of a current claim based on categorized and aggregated historical claim data.

Note that insurance claims having multiple potential outcomes may be difficult to evaluate. In the case of medical claims, for example, the extent of a claimant's future medical recovery is both indeterminate and inversely related to total claim cost (i.e., total severity). In some cases, an insurer may have access to historical claim data (e.g., the insurer may have received claim data associated with various insurance claims). The foregoing description provides examples relating to medical insurance claims but embodiments are limited thereto. For example, data entry terminals operated by a billing entity (e.g., a hospital, a physician's office, a pharmacy) or by a claim processor entering data received from a billing entity may provide such information to an insurer. The claim data may include patient identification information, a service date, a description (e.g., of a procedure or a drug), a billing code (CPT ICD-9, Rev Codes, HCPCS), and/or a cost. The claim data may include any other suitable information related to a claim. Examples include patient height, patient weight, health risks and diagnosis.

A categorical aggregation component may identify claim categories based on the historical claim data, where each of the one or more claim categories may be associated with a respective set of claim characteristics. Claims of the historical claim data which are associated with one of the claim categories are identified, each identified claim is assigned to one of a plurality of total severity ranges based on the total severity of the identified claim, and an average cost per claim year may be determined for claims of each total severity range.

A claim evaluation component may access the categorized and aggregated historical claim data, receive claim data of a current claim, identify a pre-defined claim category based on the current claim data, calculate an estimated cost of the current claim for each of a plurality of outcome scenarios based on historical claim data associated with the pre-defined claim category, and/or determine a likelihood associated with each of the plurality of outcome scenarios based on the categorized and aggregated historical claim data associated with the pre-defined claim category when executed by the computer processor.

FIG. 3 is a flow diagram of process that may facilitate determination of information about a stream of future payments according to some embodiments. Initially, at 305, historical claim data is received. As described above, historical claim data may include patient identification information, a service date, a description, a billing code, a cost, and any other suitable information that is or becomes known. The historical claim data may be received from systems of a single operating entity (e.g., a single insurance company), from several operating entities, from relevant literature (e.g., studies, reports, trials), and from any other claim data source.

Next, at 310, one or more claim categories are identified based on the received historical claim data. Each of the one or more claim categories is associated with a respective set of claim characteristics. According to some embodiments, the historical claim data is filtered based on one or more characteristics (described below) prior to identifying the claim categories. Such filtering may provide improved results and/or speed processing by removing less relevant data from the historical data.

According to some embodiments, a claim category is identified at 310 by first determining a set of claim characteristics which define claims of particular interest. The set of characteristics may be determined based on scientific literature, the historical claim data, medical expertise, claim adjusting expertise and/or professional actuarial experience. For example, the present inventors have discovered that a significant percentage of non-traumatic back surgery claims exhibit high total severity while a significant percentage of non-traumatic back surgery claims exhibit low total severity. Accordingly, these types of claims are believed to form a category of claims which may be amenable to subsequent analysis according to some embodiments. A set of claim characteristics (e.g., billing code, procedure type, co-morbidities, individual claimant data (e.g., age, industry, type of work)) which define non-traumatic back surgery claims is therefore determined at 310.

Next, claims of the historical claim data which exhibit the determined set of claim characteristics are identified, and it is determined whether the number of the identified claims exceeds a statistical significance threshold. This check may be desirable to insure that the number of claims is suitable to produce statistically relevant aggregations that may be reliably employed in subsequent analysis.

If the number of claims exceeds the statistical significance threshold, a total severity statistical profile is determined based on a total severity of each of the first claims. If the total severity statistical profile meets predefined profile criteria, a claim category is created and is associated with the determined set of claim characteristics. The total severity statistical profile and the predefined profile criteria may be defined and determined based on known statistical techniques, with the goal of ensuring that the total severities of the identified claims are suitable for analysis as will be described below.

According to some embodiments, one or more subcategories may be defined based on an identified claim category. Each subcategory of a category is associated with a set of characteristics which is a subset of the set of characteristics associated with the category. Identification of subcategories may proceed according to the above example of category definition. For example, the present inventors have identified the subcategories “cervical” and “lumbar” of the category “non-traumatic back surgery”, the sub-subcategories “fusion” and “no fusion” of the subcategory “lumbar surgery”, and the sub-subcategories “fusion” and “no fusion” of the subcategory “cervical surgery”. Each of the categories, subcategories and sub-subcategories correspond to a respective procedure code in some embodiments, which facilitates the identification of related historical claim data.

Identification of claim categories may therefore proceed iteratively, where a first set of characteristics is initially identified and then refined based on the claim data of associated claims. Moreover, any statistical profile criteria may be used to evaluate the suitability of a claim category and its underlying claim characteristics.

Claims associated with one of the claim categories are identified at 315. Such identification may include comparing claims of the historical data with a set of claim characteristics associated with the subject claim category. Each identified claim is then assigned to one of a plurality of severity ranges based on its total severity at 320.

The foregoing example uses the severity ranges “Bottom 20%”, “Middle 60%” and “Top 20%”, but embodiments are not limited thereto. Accordingly, based on their total severities, each claim of the claim category is assigned to one of these three severity ranges at 320.

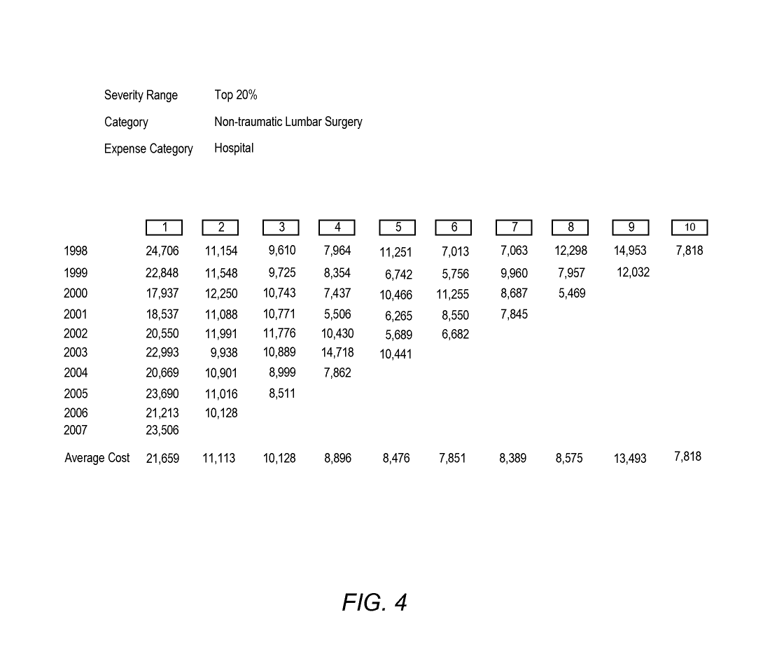

Next, at 325, an average cost per claim year is determined for the claims of each total severity range. According to the present example, the determined average cost per claim year is divided amongst expense categories (e.g., Hospital, Physician, Prescription, Other). FIG. 4 illustrates the calculation of an average cost per claim year for hospital expenses for claims of the “Top 20%” total severity range. As shown, these claims are associated with a claim category “non-traumatic lumbar surgery”. The 1998 total for claim year 2, for example, represents an average hospital cost in 1998 for claims of the Top 20% total severity range for which 1998 was the second claim year.

Returning to process 300, some embodiments further determine, for claims existing in each of claim years 2 through X, a ratio between a number of claims in the claim year to a number of claims in year 1. These ratios are determined for each expense category and for each range of total severities.

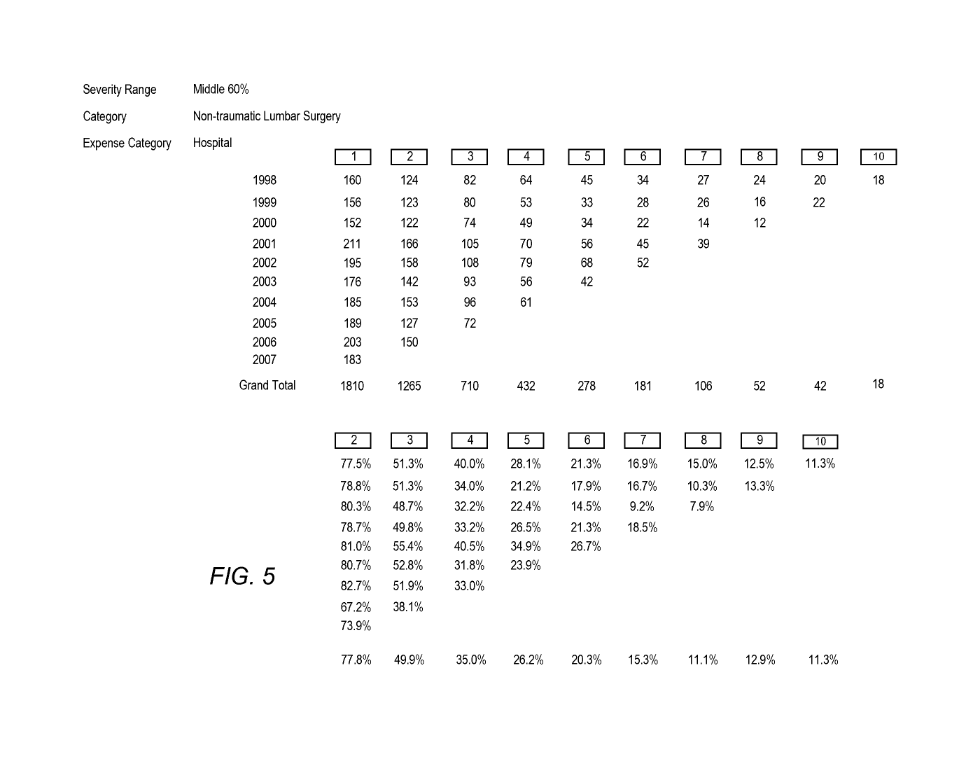

FIG. 5 illustrates calculation of the above-described ratios for each of claim years 2 through X, for the “Middle 60%” total severity range and the hospital expense category. The upper table provides a number of claims within the Middle 60% total severity range which did not settle (i.e., arose in a non-settlement jurisdiction and/or exhibited actual medical closure) and for which a hospital expense was incurred in a given claim year. Again, this information is determined from the historical claim data associated with claims falling under the “non-traumatic lumbar surgery” claim category.

The lower table shows the ratios determined at 330 according to some embodiments. The ratios for a given claim year are determined by dividing a claim count during the claim year by a corresponding claim count during year 1. For example, the ratio for year 2 (77.8%) is equal to the claim count for claim year 2 (i.e., 1265) divided by the claim count in claim year 1 for those claims which have matured to at least year 2 (i.e., 1810−183=1627). Similarly, the ratio for year 4 (35.0%) is equal to the claim count for claim year 4 (i.e., 432) divided by the claim count in claim year 1 for those claims which have matured to at least year 4 (i.e., 1810−183−203−189=1235).

Flow continues from 335 to 340 if any subcategories have been identified. For each such subcategory, a determination is made as to what percentage of the subcategory's claims is associated with each of the plurality of total severity ranges. By definition, the claims of the associated category are segmented according to the severity ranges (e.g., 20%/60%/20%), but at 340 it is determined what percentage of the subcategory's claims fall in each of the Top 20%, Middle 60% and Bottom 20% ranges. For example, it may be determined that, in the “fusion” subcategory of the “non-traumatic lumbar surgery” category, 40% of the claims are claims which are associated with the Top 20% severity range of the “non-traumatic lumbar surgery” category, 52% of the claims are claims which are associated with the Middle 60% severity range, and 8% of the claims are claims which are associated with the Bottom 20% severity range.

If additional claim categories exist, flow returns to 315 from 345 and continues as described above with respect to another claim category. Otherwise, flow terminates.

The information determined at 325, 330 and 340 of process 300 is referred to herein as categorized and aggregated historical claim data. Embodiments may determine less, more and/or different data than that described above. The categorized and aggregated historical claim data may be output and subsequently used to determine claim severities and associated likelihoods according to some embodiments. Examples of these determinations are set forth in detail below.

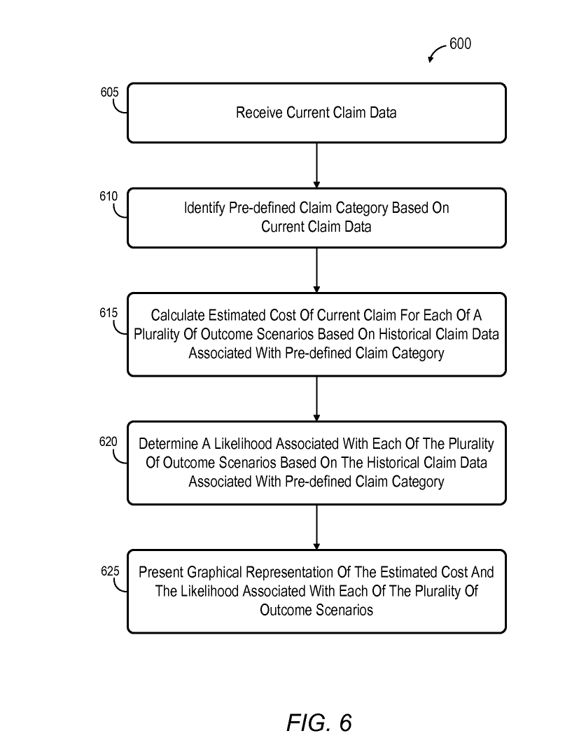

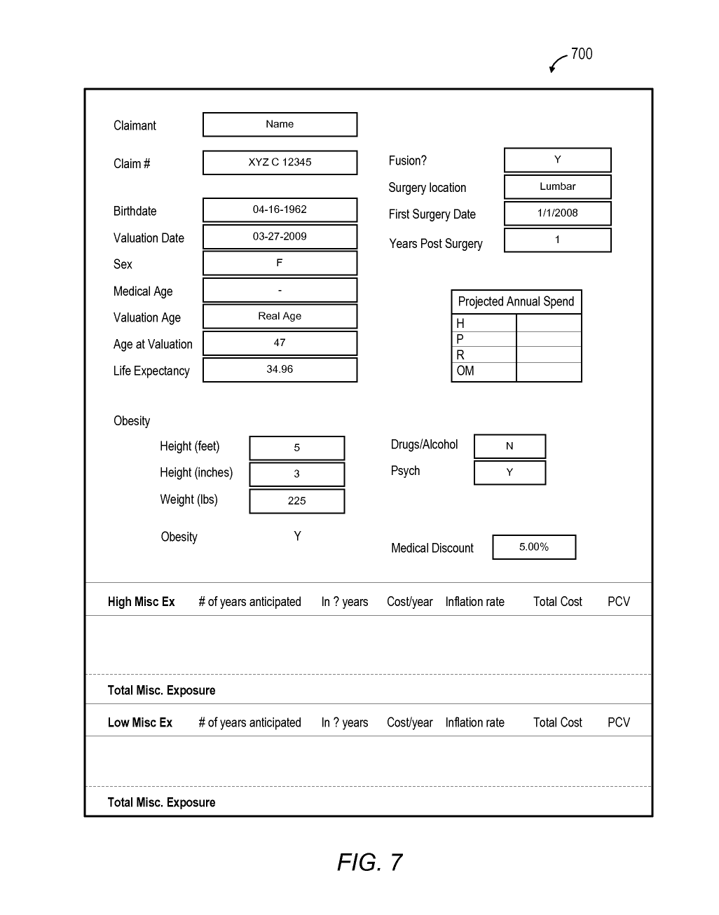

FIG. 6 is a flow diagram of process 600 to evaluate claim outcomes associated with a stream of future payments according to some embodiments. Current claim data is received at 605. The current claim data may be received from any storage device, such as but not limited to a data warehouse. Some or all of the current claim data may be received from an adjuster via a user interface. FIG. 7 is an outward view of user interface 700 to receive current claim data according to some embodiments.

According to some embodiments, an adjuster operates a computer system to execute a claim evaluation component. In response, an output device may display the user interface 700 to the adjuster. User interface 700 includes fields that may be pre-populated based on current claim data stored in the system. The adjuster may also or alternatively populate the fields with data received from disparate sources, such as other claim review databases, physical files, etc. Notably for purposes of the present examples, user interface 700 includes fields for indicating co-morbidities (i.e., obesity, drugs/alcohol/psych), surgery type (i.e., “Fusion?” lumbar), and projected annual expenditures for various expense categories (i.e., (H)ospital, (P)hysician, p(R)escription, and Other Medical (OM)). Tables are also provided for entering other known or expected miscellaneous exposure information that may be used to enhance the subsequent evaluation.

At 610, a pre-defined claim category is identified based on the received current claim data. It will be assumed that the pre-defined claim category is a claim category determined according to 310 of process 300, but embodiments are not limited thereto. In some embodiments of 610, it is determined that the current claim data exhibits a set of characteristics that is associated with a pre-defined claim category. With respect to the present example, the pre-defined claim category is the “non-traumatic lumbar surgery” category described above.

Next, at 615, an estimated cost of the current claims is calculated for each of a plurality of outcome scenarios based on historical claim data associated with the pre-defined claim category. The estimated cost may be determined based on categorized and aggregated historical data in some embodiments. For example, the estimated cost attributable to hospital expenses for a high-cost (e.g., Top 20% severity) outcome scenario may be determined based on the categorized and aggregated historical data of FIG. 4.

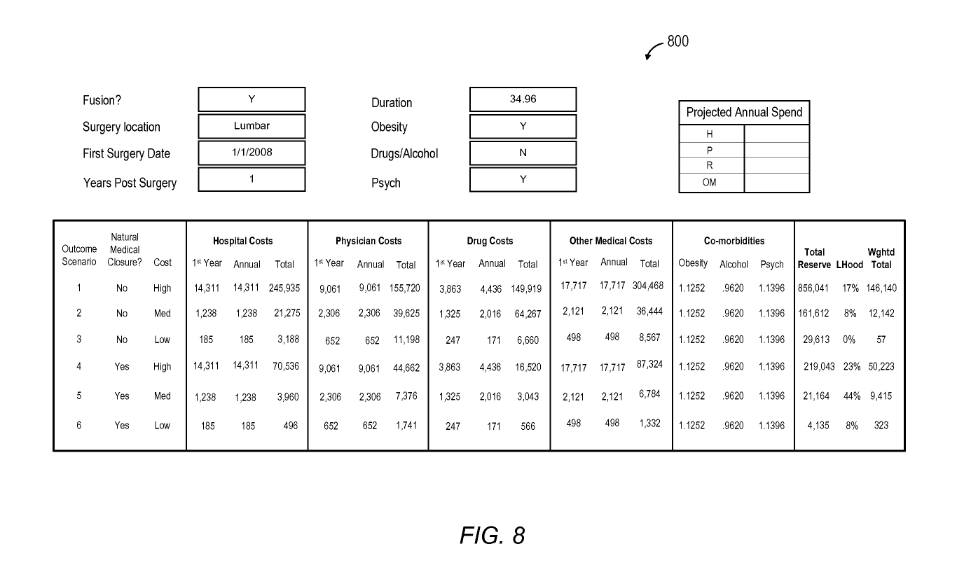

FIG. 8 illustrates graphical representation 800 for purposes of explaining some embodiments of 615. Graphical representation 800 may be presented to an adjuster at 625 of process 600 as will be described below.

In the present example, the annual hospital cost for the high-cost outcome scenario after the first year is determined by first calculating the average of the average costs shown in FIG. 4. This average is multiplied by the factors associated with any existing co-morbidities. Specifically, the average (i.e., $11,161) is multiplied by the obesity factor (1.1252) and the psych factor (1.1396) to determine an annual cost (i.e., $14,311). This annual cost is used in representation 900 unless a greater projected annual spend is received in 605 (e.g., from an adjuster), in which case the projected annual spend is used as the annual cost. The corresponding first year hospital costs are determined to be equal to the annual cost.

The total attributable to hospital costs is the present value of the annual costs over the listed claim duration (i.e., 34.96 years) and at the listed discount rate (i.e., 5.00%), plus the first year costs. Embodiments are not limited to the foregoing calculations.

The remaining rows of the Hospital Costs portion of representation 800 may be completed as described based on categorized and aggregated historical claim data. However the data used to complete the rows includes average costs per claim year for claims in the subject category and in the severity range (i.e., Middle 60%, Bottom 20%) corresponding to the row to be completed. The Physician Costs portion, Drug Costs portion, and Other Medical Costs portion of representation 800 may be similarly completed using similar categorized and aggregated historical data, albeit associated with the appropriate expense category and severity range.

The estimated cost of the current claim for each of the six outcome scenarios is shown in the Total Reserve column of representation 800. The Total Reserve for a given outcome scenario is determined by summing all the Total columns in the row associated with the outcome scenario. Again, embodiments are not limited to the specific calculations set forth herein.

Returning to FIG. 6, a likelihood associated with each of the plurality of outcome scenarios is determined at 620. The likelihood is determined based on the historical claim data associated with the subject claim category.

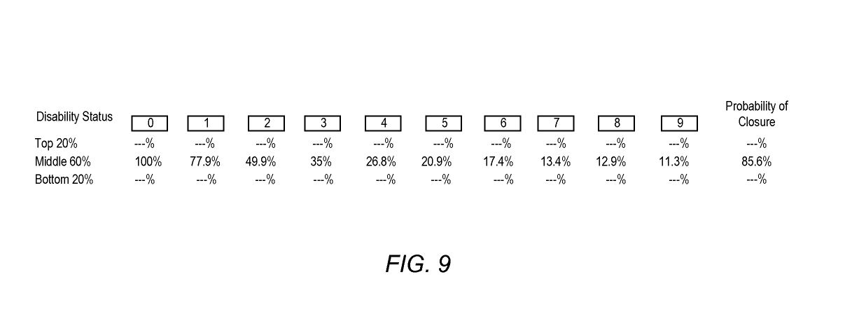

The LHood column of FIG. 8 indicates likelihoods calculated according to some embodiments of 620. The likelihoods may be calculated based on categorized and aggregated historical claim data such as that illustrated in FIG. 5. FIG. 9 illustrates previously-determined ratios between a number of claims in a given claim year to a number of claims in year 1. These ratios may comprise the ratios corresponding to a single expense category. In embodiments such as that depicted in FIG. 9, the ratio illustrated for a given claim year and severity range is the maximum of the ratios calculated for each expense category for the given claim year and severity range. Accordingly, some but not all of the ratios depicted in FIG. 9 are identical to those shown in FIG. 5 in association with the hospital expense category.

Continuing with the determination at 620, a probability of closure is determined for each severity range. The probability of closure shown in FIG. 9 is calculated as (1-Ratio_{Yr9}/Ratio_{CurrentYr}). Embodiments are not limited to this calculation.

For scenarios associated with no Natural Medical Closure (i.e., scenarios 1-3), the likelihoods are calculated for each severity range as (%claims_{SeverityRange}(1−Probability of Closure_{SeverityRange})). Conversely, for scenarios associated with a Natural Medical Closure (i.e., scenarios 4-6), the likelihoods are calculated for each severity range as (%claims_{SeverityRange}(Probability of Closure_{SeverityRange})). In a case that the current claim is associated with a subcategory of the identified claim category, the values %claims_{SeverityRange} may be those percentages generated at 340 of process 300. According to the illustrated example, the percentages corresponding to the Top 20%, Middle 60% and Bottom 20% severity ranges for the “fusion” subcategory are 40%, 52% and 8%, respectively. Other percentages may be employed in a case that current claim is associated with a “no fusion” subcategory.

A graphical presentation of the estimated cost (i.e., Total Reserve) and likelihood (i.e., LHood) of each outcome scenario is presented at 625. The graphical representation may comprise representation 800, but embodiments are not limited thereto. Thus, the embodiments described with respect to FIGS. 3 through 9 herein may be used to help determine information about a stream of future payments that might be associated with, for example, a workers' compensation claim. For example, embodiments may automatically determine payment values associated with a stream of future payments based at least in part on the injury information (e.g., which may map to a claim category or sub-category).

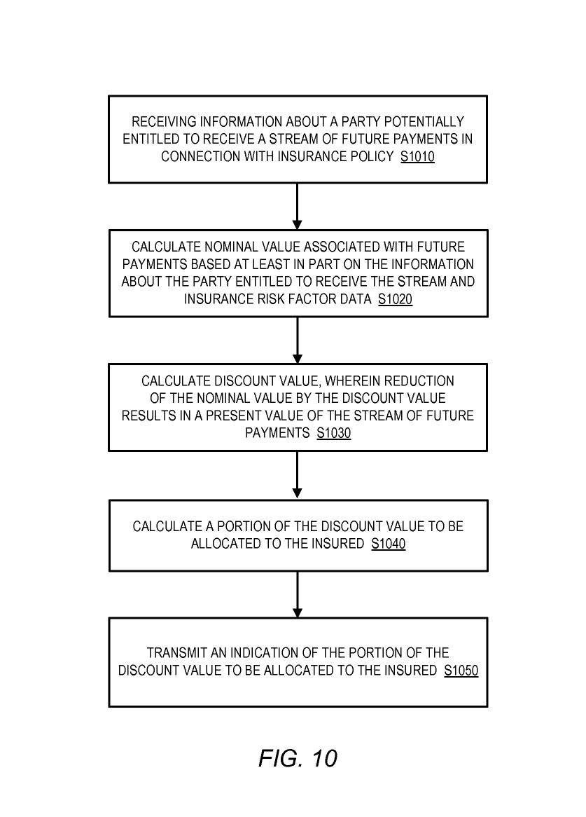

FIG. 10 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

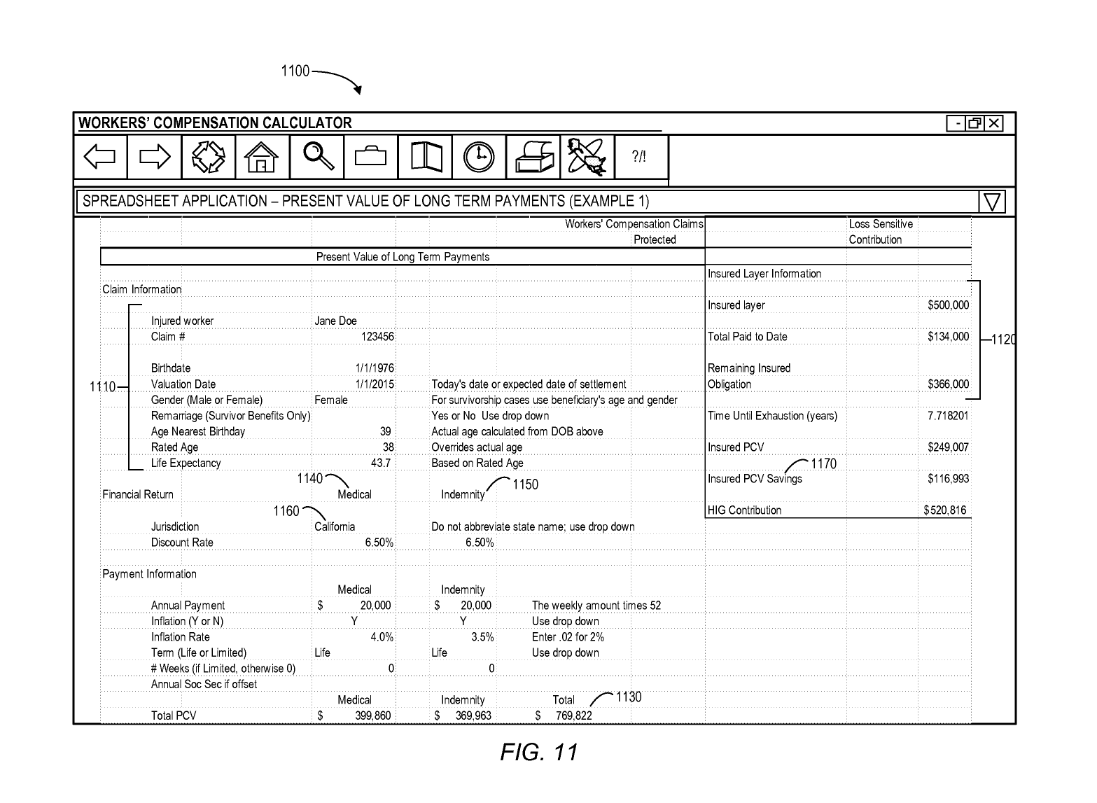

At S1010, information about a party potentially entitled to receive a stream of future payments in connection with an insurance policy may be received. For example, an employer (the “insured”) might purchase a workers' compensation insurance policy from an insurer. Moreover, an injured worker may be entitled to the stream of future payments in accordance with the workers' compensation insurance policy (e.g., as entered by a claim handler or determined as described with respect to FIGS. 3 through 9 or by any other process). FIG. 11 is an example of an allocation user interface 1100 associated with a first example in accordance with some embodiments. In particular, the interface 1100 displays information about the worker (“Jane Doe”) 1110, some of which has been input to a present value calculation platform. The input information about the worker 1110 might include, for example, the worker's name, date of birth, gender, etc. Other information about the worker 1110 might be automatically calculated by the present value calculation platform, such as a life expectancy value (“43.7 years” in the example of FIG. 11).

Referring again to FIG. 10, a nominal value associated with the stream of future payments may be automatically calculated at S1020 based at least in part on the information about the party potentially entitled to receive the stream of future payments and insurance risk factor data. The insurance risk factor data may, for example, include mortality data and the information about the party potentially entitled to receive the stream of future payments might include a date of birth, an age, and/or a gender. In the example of FIG. 11, the nominal value might be displayed 1120, including values associated with the insured layer (where the layer represents a maximum amount to be paid by a party), the total paid to date, and the remaining obligation of the insured.

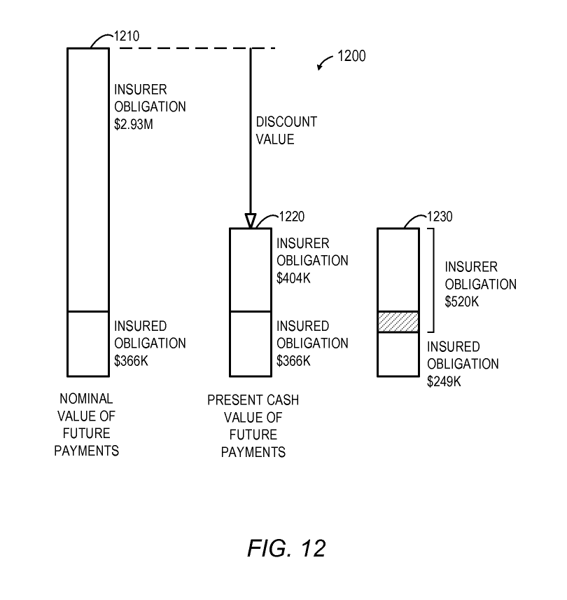

Referring again to FIG. 10, a discount value may be calculated at S1030, wherein reduction of the nominal value by the discount value results in a present value of the stream of future payments (e.g., a Present Cash Value (“PCV”) or a Net Present Value (“NPV”)). In the example of FIG. 11, the present value represents a total PCV 1130. FIG. 12 is a bar graph 1200 illustrating difference between various types of allocation schemes in accordance with some embodiments. In this example, nominal amounts 1210 of $2.93 million (by the insurer) and $366,000 (by the insured) are owed to a worker. After being reduced by a discount value, PCV amounts 1220 of $404,000 (by the insurer) and $366,000 (by the insured) may be owed to the worker. That is, payment of the PCV amounts today may be considered equivalent to paying the nominal amounts 1210 over a period of time.

According to some embodiments, calculating the discount value includes associating a first part of the stream of future payments with a medical inflation rate and a second part of the stream of future payments with a cost of living inflation rate. Referring to FIG. 11, the user interface 1100 may include a medical discount rate 1140 (e.g., based on projected future medical cost increases) and an indemnity discount rate 1150. The indemnity discount rate 1150 may be, according to some embodiments, automatically determined based on a location of the stream of future payments. In the example of FIG. 11, the jurisdiction 1160 of “California” is associated with a medical indemnity discount rate 1150 of “6.5%.

Note that in the example of FIG. 12, applying the discount value reduced the obligation of the insurer (from $2.93 million to $404,000) but did not change the obligation of the insured (which remained at $366,000). Referring again to FIG. 10, according to some embodiments described herein a portion of the discount value to be allocated to the insured may be calculated at S1040, and an indication of the portion of the discount value to be allocated to the insured may be transmitted at S1050. In the example of FIG. 12, such an allocation 1230, represented by the cross-hatched area, reduces the obligation of the insured from $366,000 to $249,000 (while the obligation of the insurer rose from $404,000 to $520,000. Such an approach may, for example, make the insured more likely to approve a single, present day payment to the worker. Note that the allocation does not impact the overall value that will be received by the worker from the insured and insurer. In the example of FIG. 11, the PCV savings 1170 of the insured is $116,993. According to some embodiments, a premium associated with a workers' compensation insurance policy may be adjusted based at least in part on this ability to allocate a portion of the discount value to the insured employer. The adjusting might be associated with, for example, a credit or a debit for the insurance premium.

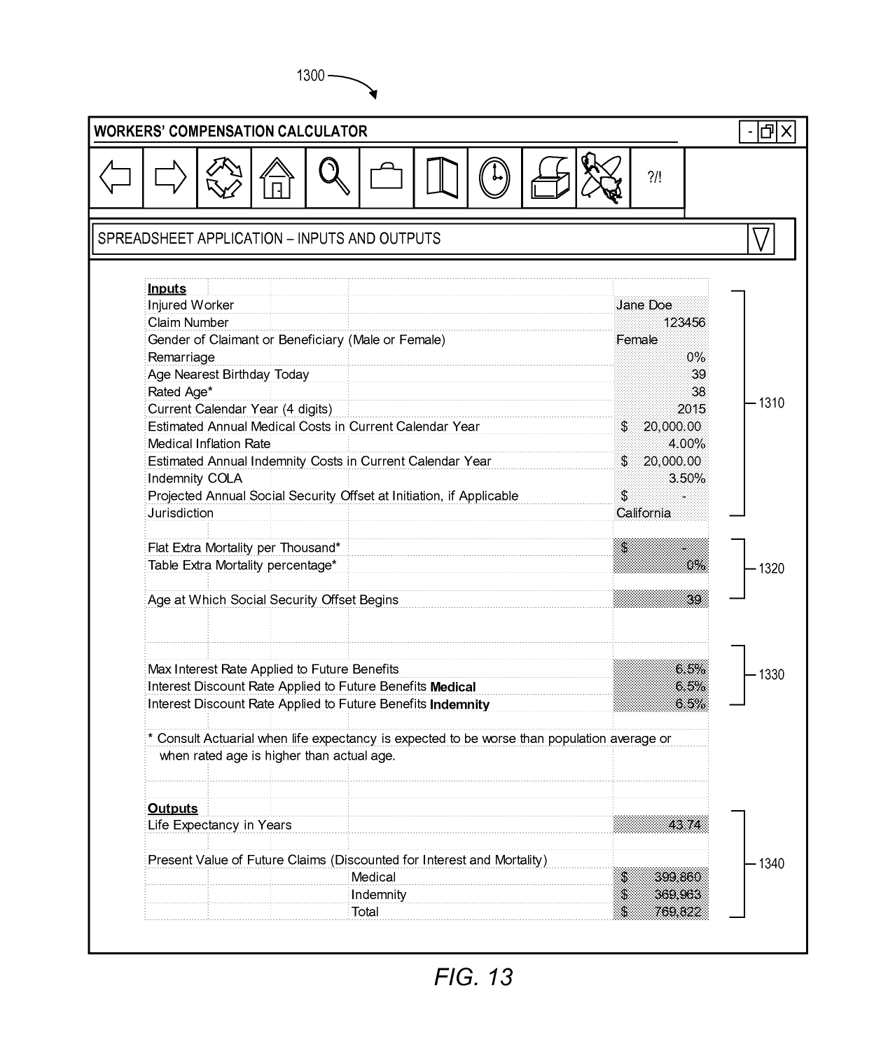

The information may be input into and received from a present value calculation platform 150 in a number of different ways. FIG. 13 is an example of an input output user interface 1300 associated with the first example according to some embodiments. The interface 1300 includes a first input area 1310 where information can be input by a claim handler. Such information might include, for example, a worker's name, a claim number, a gender, a remarriage indication, an age, a current year, estimated annual medical costs, a medical inflation rate, an estimated annual indemnity cost, an indemnity Cost Of Living Adjustment (“COLA”), a projected annual Social Security offset, and jurisdiction information associated with the claim.

The interface 1300 may also include a second area 1320 where a claim handler might override a formula. A third input area 1330 may be associated with interest rates to be used to determine a discount value (including maximum, medical, and indemnity rates). The interface also includes an output area 1340 which might display, for example, a life expectancy in years, a present value of future claims (discounted for interest and mortality) comprising: a medical portion and an indemnity portion which may be summed and displayed as a total resent value.

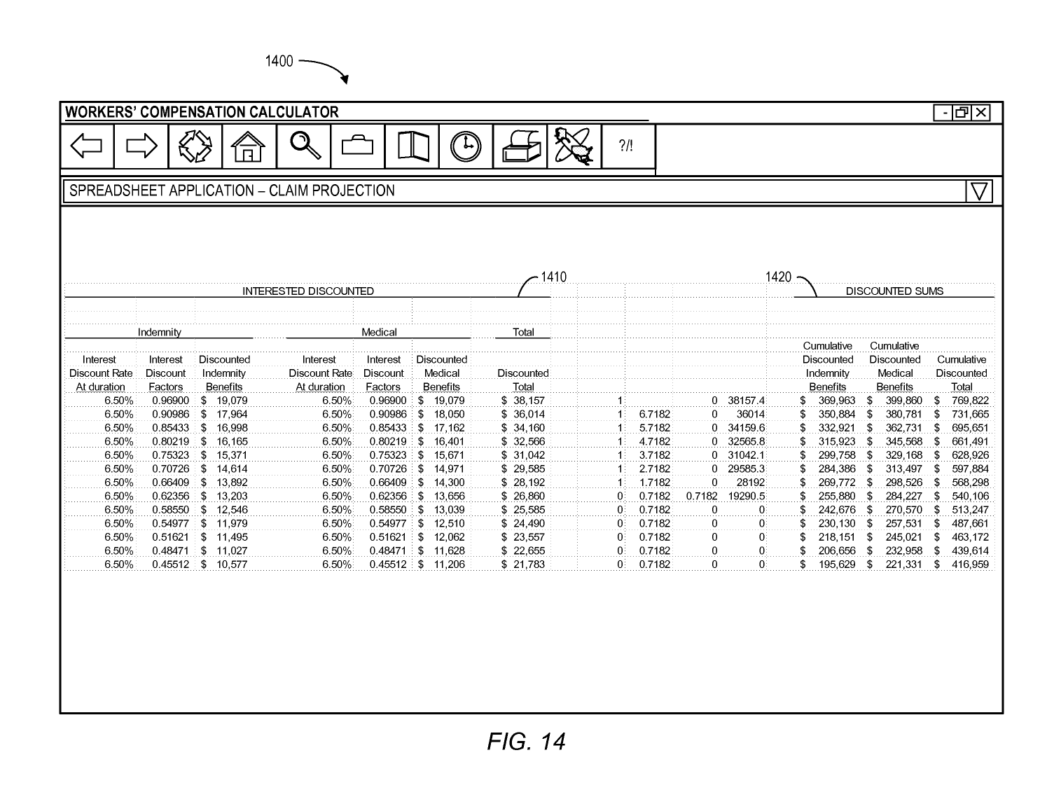

The information on the input output user interface 1300 may be used, according to some embodiments, to project future claim amounts. FIG. 14 is an example of a claim projection user interface 1400 associated with a first example in accordance with some embodiments. In particular, the interface includes both indemnity and medical discount rates and associated benefits 1410. The interface 1400 also includes discounted sums 1420 associated with both indemnity benefits and medical benefits (along with a total cumulative discounted amount).

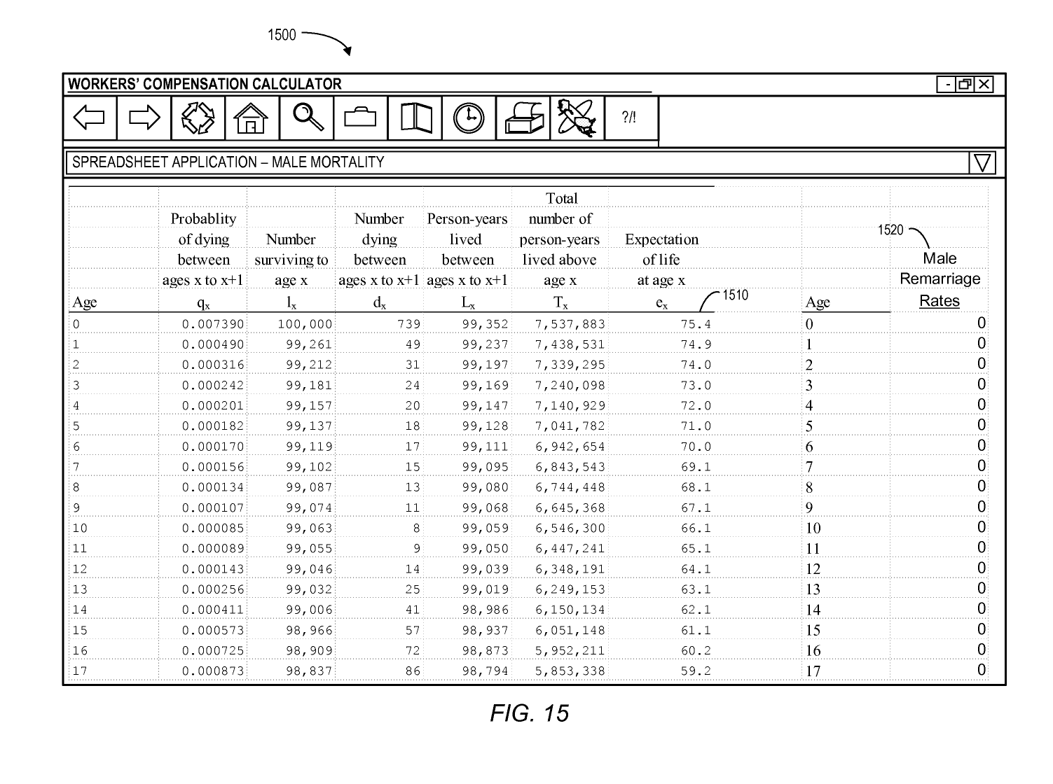

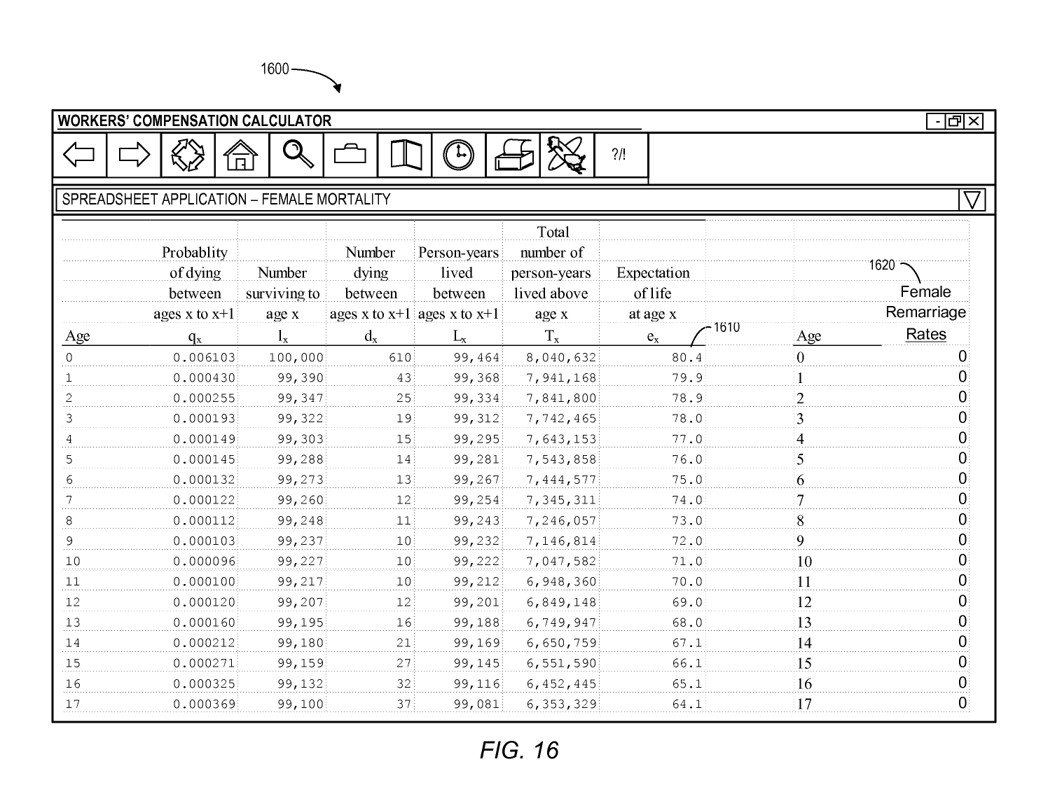

According to some embodiments, mortality information is used to determine a life expectancy (e.g., based on a worker's current age). FIG. 15 is an example of a male mortality user interface 1500 in accordance with some embodiments. For each age x, the interface 1500 displays 1510 a probability of dying between age x and age x+1 (qₓ), a number of people surviving to age x (lₓ), a number of people dying between ages x and age x+1 (dₓ), a number of person-years lived between ages x and x+1 (Lₓ), a total number of person-years lived above age x (Tₓ), and an expectation of life at age x (eₓ). The male mortality interface 1500 may further include male re-marriage rates 1520 (e.g., when a claim is associated with survivorship benefits). Similarly, FIG. 16 is an example of a female mortality user interface 1600 in accordance with some embodiments. As before, for each age x, the interface 1600 displays 1610 a probability of dying between age x and age x+1 (qₓ), a number of people surviving to age x (lₓ), a number of people dying between ages x and age x+1 (dₓ), a number of person-years lived between ages x and x+1 (Lₓ), a total number of person-years lived above age x (Tₓ), and an expectation of life at age x (eₓ) along with female re-marriage rates 920 (e.g., when a claim is associated with survivorship benefits).

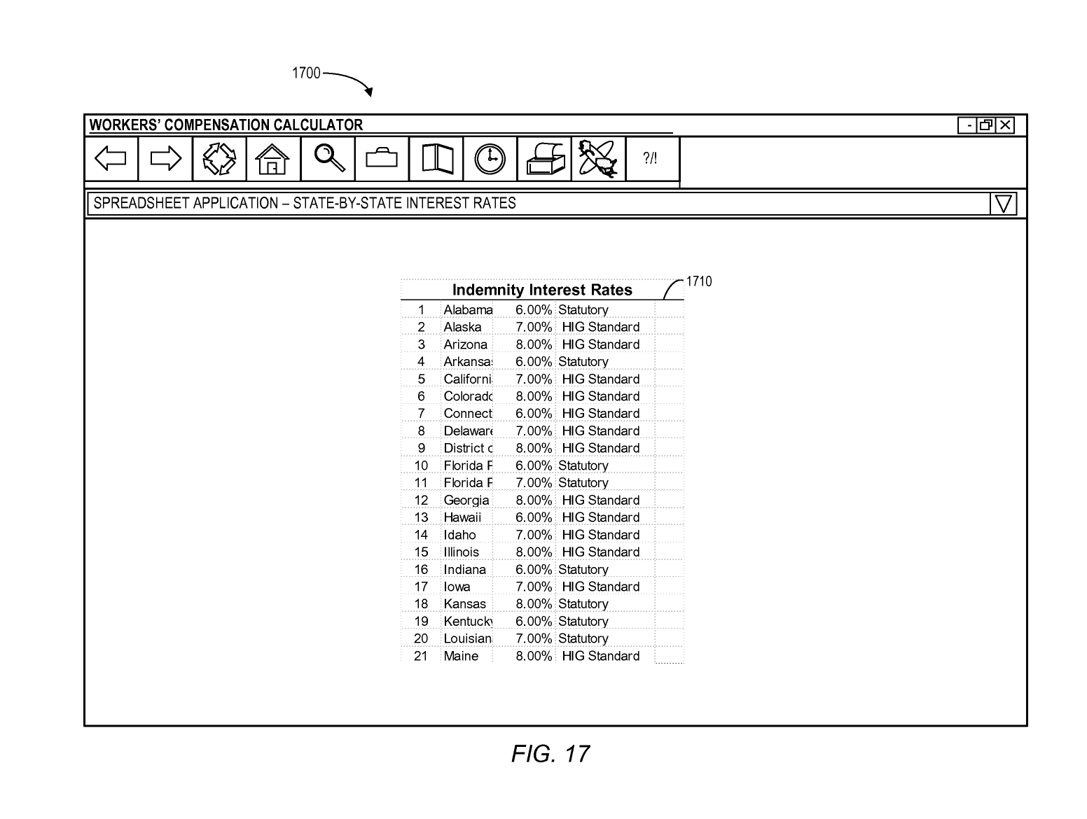

According to some embodiments, a medical discount rate and/or an indemnity discount rate (e.g., a non-medical portion of an obligation) may be automatically determined based on projections and/or a location associated with a claim. For example, different states may have different mandatory values that must be used in connection with workers' compensation benefit calculations. FIG. 17 is an example of a state-by-state interest rate user interface 1700 in accordance with some embodiments. The interface 1700 includes, for each state, indemnity discount rate information 1710 (e.g., a rate of “8.00%” is used for Kansas as mandated by statute while an insurer's standard rate of “7.00%” is used for Idaho).

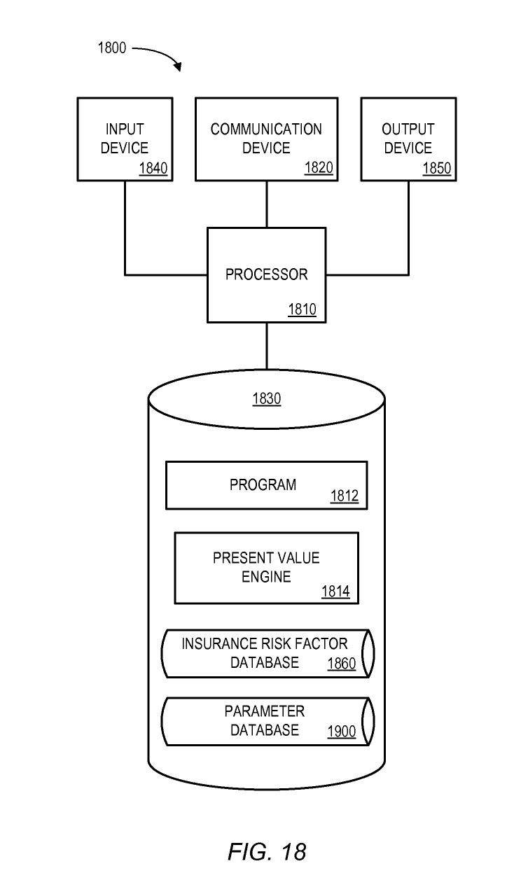

The embodiments described herein may be implemented using any number of different hardware configurations. For example, FIG. 18 illustrates a present value platform 1800 that may be, for example, associated with the system 100 of FIG. 1. The present value platform 1800 comprises a processor 1810, such as one or more commercially available Central Processing Units (CPUs) in the form of one-chip microprocessors, coupled to a communication device 1820 configured to communicate via a communication network (not shown in FIG. 18). The communication device 1820 may be used to communicate, for example, with databases to receive insurance risk factor information. The present value platform 1800 further includes an input device 1840 (e.g., a mouse, a keyboard, a touch screen, or a microphone associated with claim handler to receive information about a workers' compensation claim) and an output device 1850 (e.g., to output reports and the results of allocation calculations). Note that the present value platform 1800 might be associated with an insurer.

The processor 1810 also communicates with a storage device 1830. The storage device 1830 may comprise any appropriate information storage device, including combinations of magnetic storage devices (e.g., a hard disk drive), optical storage devices, mobile telephones, and/or semiconductor memory devices. The storage device 1830 stores a program 1812 and/or a present value engine 1814 for controlling the processor 1810. The processor 1810 performs instructions of the programs 1812, 1814, and thereby operates in accordance with any of the embodiments described herein. For example, the processor 1810 may automatically calculate a nominal value associated with a stream of future payments based at least in part on information about a party potentially entitled to receive the stream of future payments and insurance risk factor data. A discount value may also be automatically calculated by the processor 1810, such that reduction of the nominal value by the discount value results in a present value of the stream of future payments. A portion of the discount value to be allocated to the insured may be automatically determined by the processor 1810, and an indication of that portion may be transmitted.

The programs 1812, 1814 may be stored in a compressed, uncompiled and/or encrypted format. The programs 1812, 1814 may furthermore include other program elements, such as an operating system, a database management system, and/or device drivers used by the processor 1810 to interface with peripheral devices.

As used herein, information may be “received” by or “transmitted” to, for example: (i) the present value platform 1800 from another device; or (ii) a software application or module within the present value platform 1800 from another software application, module, or any other source.

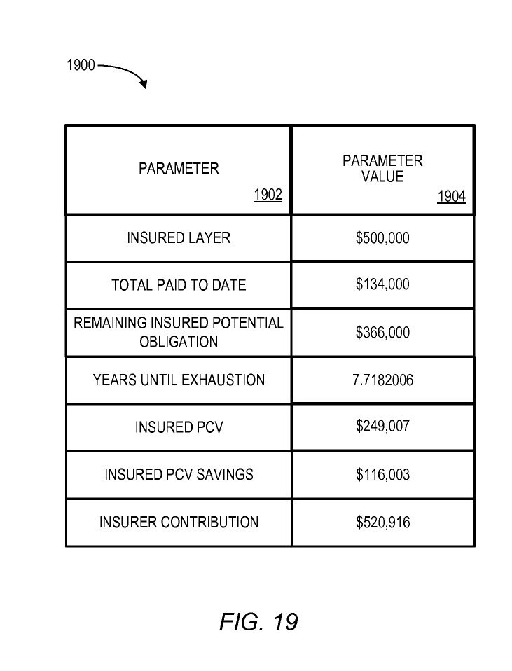

In some embodiments (such as shown in FIG. 18), the storage device 1830 further stores an insurance risk factor database 1860 (e.g., containing mortality data for various ages and genders) and a parameter database 1900 (e.g., to store inputs and automatically calculated outputs). An example of a database that may be used in connection with the present value platform 1800 will now be described in detail with respect to FIG. 19. Note that the database described herein is only one example, and additional and/or different information may be stored therein. Moreover, various databases might be split or combined in accordance with any of the embodiments described herein. For example, the insurance risk factor database 1860 and/or parameter database 1900 might be combined and/or linked to each other within the present value engine 1814.

Referring to FIG. 19, a table is shown that represents a parameter database 1900 that may be stored at the present value platform 1800 according to some embodiments. The table may include, for example, entries identifying different insurance parameters entered into or calculated by the present value platform 1800 and may, according to some embodiments, be associated with a spreadsheet application. The table may also define fields 1902, 1904 for each of the entries. The fields 1902, 1904 may, according to some embodiments, specify: a parameter 1902 and a parameter value 1904. The parameter database 1900 may be created and updated, for example, as information is received from a claim handler or application designer and/or as calculations are performed by the present value platform 1800.

The parameter 1902 may be, for example, a unique alphanumeric code identifying a particular input or output parameter associated with the present value platform 1100, and the parameter value 1904 may store the current value of that parameter. The illustration of FIG. 19 generally includes loss sensitive contribution parameters in accordance with the first example of FIG. 11, including an automatically calculated insured PCV savings of $116,003.

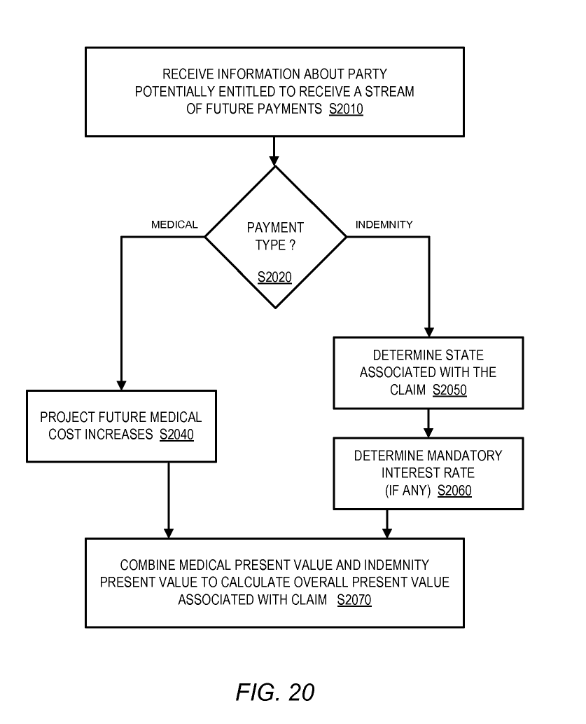

According to some embodiments, different medical discount rates and indemnity discount rates may be automatically determined and/or applied in connection with a workers' compensation insurance claim. FIG. 20 illustrates a present value calculation method that might be performed in accordance with some embodiments. At S2010, information about a party potentially entitled to receive a stream of future payments may be received. For each of the future payments (or portions of future payments), it may be determined if the payment type is considered “medical” at S2020. If the payment type is “medical” at S2020, future projected medical costs may be used to determine a discount rate at S2040. If the payment type is instead “indemnity” at S2020, the state associate with the claim is determined at S2050, and any mandatory interest rate (if any) may be determined for the indemnity portion at S2060. This process may be associated with, for example, the state-by-state information stored in the interface 1000 of FIG. 10. At S2060, the separately calculated medical and indemnity present values may be combined to generate an overall present value associated with the claim.

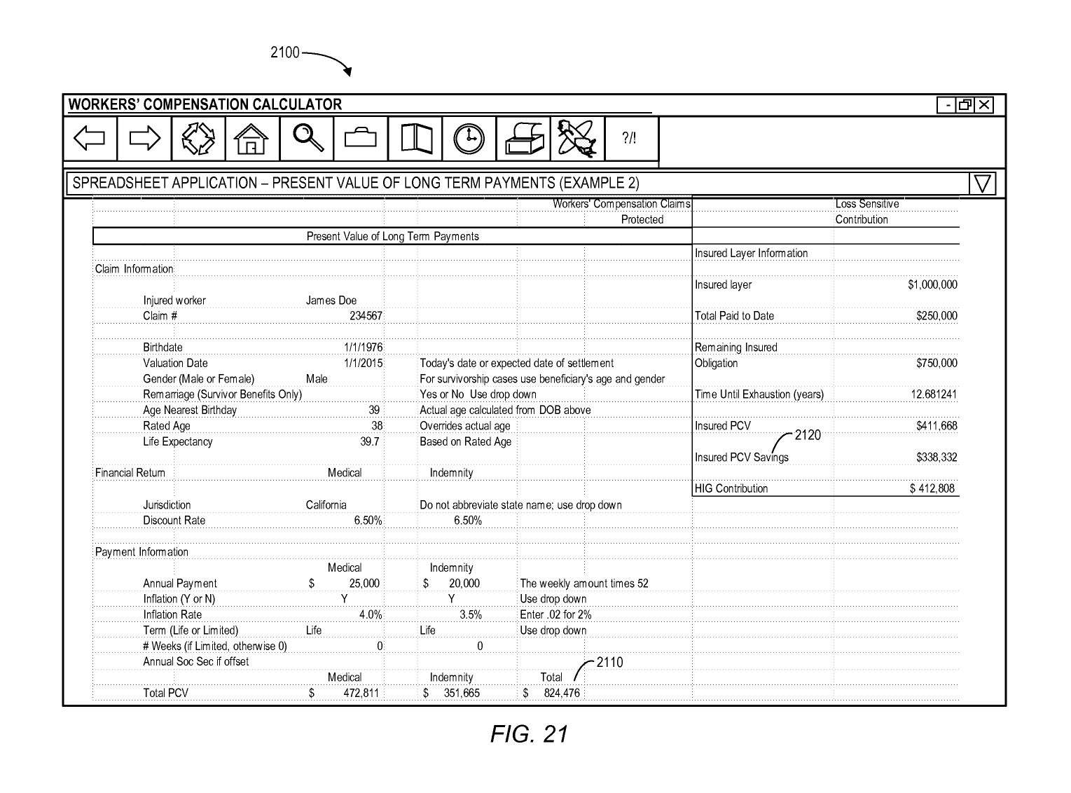

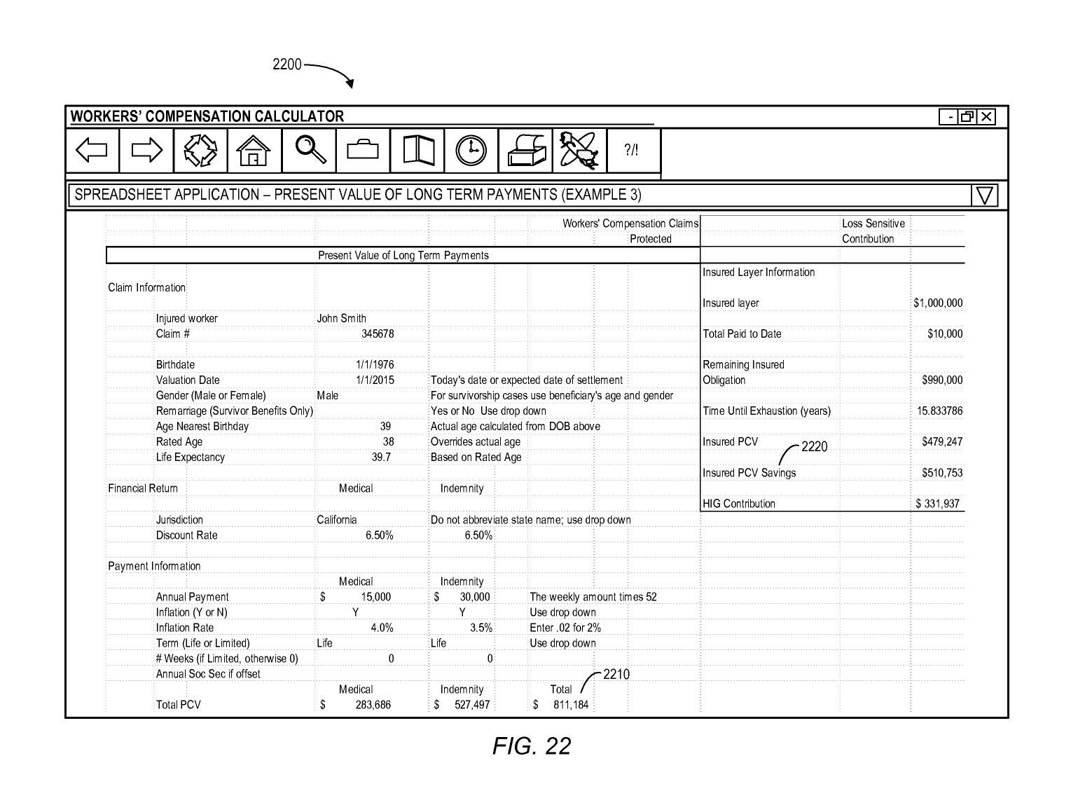

Note that the first example described with respect to FIG. 11 is only one configuration of amounts to be allocated. FIG. 21 is an example of an allocation user interface 2100 associated with a second example in accordance with some embodiments. In the second example, note that the worker is now a male (with a different life expectancy), the insured layer is $1,000,000 and $250,000 has been paid to date. As a result, the total PCV amount 2110 and the insured PCV savings 2120 are different. Similarly, FIG. 22 is an example of an allocation user interface 2200 associated with a third example in accordance with some embodiments. In this case, the medical and indemnity payment amounts have changed and the total paid to date is only $10,000. As a result, the total PCV amount 2210 and the associated insured PCV savings 2220 have again changed.

Thus, embodiments described herein may provide an insured with an allocated amount of PCV savings, which may provide them with an incentive to make a single, present day payment (as opposed to a stream of future payments). For example, if there is a claim where $50,000 a year is being spent for the foreseeable future, and the insured's layer is $500,000, the insured may be motivated to hold on to the case because $500,000 paid out over 10 years has a lower PCV as compared to $500,000 paid tomorrow. In this example, the difference is approximately $120,000. Additionally, there may be some question as to the total value of the claim where in one scenario, such as the claim may exceed $500,000 but if the injured worker recovers, the claim might not exceed $500,000. Even though these are quantifiable issues, parties may not attain optimal outcomes.

In accordance with some embodiments, a variety of claim scenarios may be executed weighted by the likelihood that they will occur. In each scenario, the system may calculate a burn rate and time until the insured's layer is exhausted. For example:

10% Scenario A—High Cost—$100,000/year

Time until exhaustion 5 years

40% Scenario B—Moderate Cost—$50,000/year

Time until exhaustion 10 years

50% Scenario C—Low Cost—$20,000/year

Time until exhaustion 25 years

The weighted average burn rate in this example is $40,000/year and the weighted time until the $500,000 layer is exhausted is 12.5 years. Running the PCV calculation, the system may automatically determine a PCV of $348,000 and a “loss” of $152,000 in present value dollars if parties agree to fund a settlement at $500,000 to close the file.

To address the question of whether the exposures will be too low to actually breach the insured layer, the system may evaluate the annual spend over the injured worker's life expectancy to come up with the total value. If that value is less than the insured layer, the likelihood of it breaching the retention may be zero.

Assume a simple case where the insured has a $500,000 layer again and the claimant's life expectancy is 25 years. Moreover:

50% Scenario A:

Claimant spends $10,000/year for the next 25 years and does not breach the retention of $500,000. Nominal value is $250,000, insured PCV is $129,000 and the insurer PCV is 0.

50% Scenario B:

Claimant spends $50,000/year for the next 25 years breaching the insured layer of $500,000. The insurer PCV would begin in 10 years and then pay out for the next 15. Nominal Value is $1.25 million, and the PCV is $644,000 ($381,000 insured and $263,000 insurer).

The weighted PCV of the claim is then (50%×$129,000)+(50%×$644,000)=$387,000 with the insurer's contribution of 50% of the insurer's PCV of $263,000=$132,000. The insurer might agree that if the insured were to contribute $255,000 here, the insurer would go up to $387,000 to resolve the matter with the injured worker capturing the PCV for both parties in both scenarios above.

In some cases, insureds may have a financial disincentive to quickly resolve cases because settlement dollars come out of financials statements all at once. Currently, insureds receive no benefit for the PCV of the time the claim would remain in their layer. According to some embodiments, an insurer might “drop down” and cover the PCV losses for insureds to resolve the cases for the benefit of all parties involved. The claimant benefits from the settlement (otherwise the parties might not settle). The insured benefits by removing the risk of a faster payout, reducing liabilities, and receiving some of the benefit of the PCV. The insurer may benefit because the risk associated with these claims is eliminated and handling expenses may be reduced.

Note that the present invention provides significant technical improvements to the calculation of allocation amounts technology. The present invention is directed to more than merely a computer implementation of a routine or conventional activity previously known in the industry as it significantly advances the technical efficiency, access and/or accuracy allocation calculations by implementing a specific new method and system as defined herein. The present invention is a specific advancement in the area of insurance allocations and/or premium pricing by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in the present invention specialized and detailed insurance risk factor information may be accessed to determine an appropriate allocation amount.

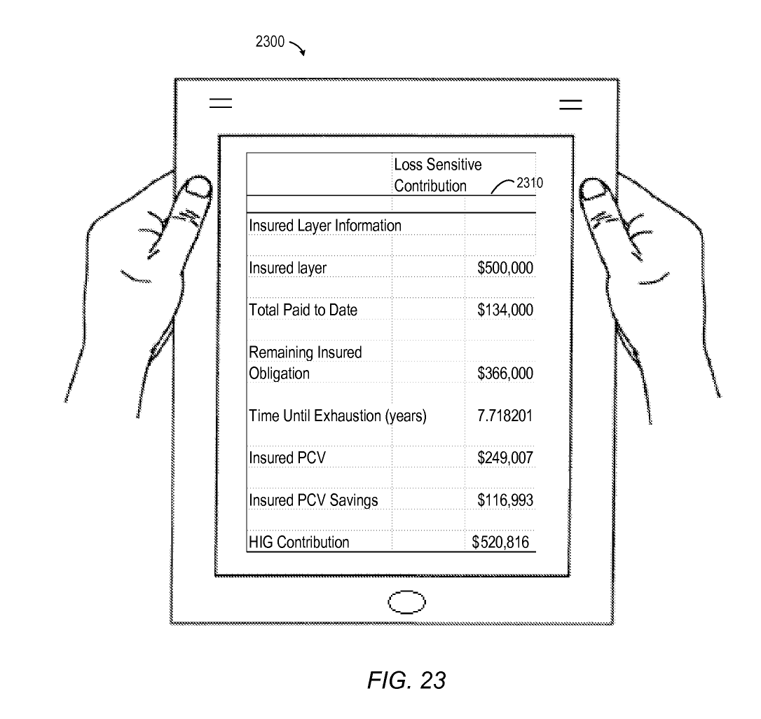

Although specific hardware and data configurations have been described herein, note that any number of other configurations may be provided in accordance with embodiments of the present invention (e.g., some of the information associated with the databases described herein may be combined or stored in external systems). Additionally, one or more of the elements described herein may be practiced in a distributed cloud computing environment where tasks are performed by logically or physically remote processing devices that are linked through one or more communications networks. For example, FIG. 23 illustrates a handheld tablet 2300 results display according to some embodiments described herein. In particular, the handheld tablet 2300 is displaying loss sensitive contribution parameters 1610 in accordance with the first example of FIG. 11, including an automatically calculated insured PCV savings of $116,003.

Although embodiments have been described with respect to a single, present day settlement, embodiments may be applied to any payment structure. For example, an a stream of future payments may be converted to a PCV, some of the PCV savings may be shared with the insured, and the single value that the insured is obligated to pay the insurer may then be translated back into a stream of future payments from the insured to the insurer (such that the entire impact of the settlement does not occur in a single financial year).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system to dynamically calculate workers' compensation insurance claim amounts, the system comprising:
an insurance risk factor computer storage unit for receiving, storing, and providing insurance risk factor data;
a processor in communication with the insurance risk factor computer storage unit, wherein the processor is configured for:
receiving information about a worker potentially entitled to receive a stream of future workers' compensation payments, including injury information,
automatically determining payment values associated with the stream of future payments based at least in part on the injury information,
automatically calculating a nominal value associated with the stream of future workers' compensation payments based at least in part on the information about the worker potentially entitled to receive the stream of future workers' compensation payments, the automatically determined payment values, and insurance risk factor data,
calculating a discount value, wherein reduction of the nominal value by the discount value results in a present value of the stream of future workers' compensation payments,
calculating a portion of the discount value to be allocated to an insured employer that purchased a workers' compensation insurance policy from an insurer, and
transmitting an indication of the portion of the discount value to be allocated to the insured.

2. The system of claim 1, wherein processor is further configured for adjusting a premium associated with the workers' compensation insurance policy based at least in part on an ability to allocate the portion of the discount value to the insured employer, wherein the adjusting is associated with one of a credit or a debit for the premium.

3. The system of claim 2, wherein another party acts as a third party administrator of the workers' compensation insurance policy.

4. The system of claim 1, wherein the insurance risk factor data includes mortality data and the information about the worker potentially entitled to receive the stream of future workers' compensation payments includes at least one of: (i) a date of birth, (ii) an age, and (iii) a gender.

5. The system of claim 1, wherein calculating the discount value includes associating a first part of the stream of future payments with a medical inflation rate and a second part of the stream of future payments with a cost of living inflation rate.

6. The system of claim 5, wherein the cost of living inflation rate is automatically determined based on a location of the stream of future payments.

7. The system of claim 1, wherein the insurance risk factor computer storage unit and the processor are associated with a computer executing a spreadsheet application template.

8. The system of clam 7, wherein the spreadsheet application template is constructed to include a claim projection portion, a male mortality portion, a female mortality portion, and a state-by-state inflation rate portion.

9. The system of claim 1, wherein the present value of the stream of future payments comprises at least one of a present cash value and a net present value.

10. The system of claim 1, wherein the processor is further configured for:
translating a single value that the insured is obligated to pay the insurer into a stream of future payments from the insured to the insurer.

11. A computerized method to dynamically calculate workers' compensation insurance claim amounts, the method comprising:
receiving information about a party potentially entitled to receive a stream of future payments in connection with the insurance policy;
automatically calculating, by a computer processor of a present value calculation platform, a nominal value associated with the stream of future payments based at least in part on the information about the party potentially entitled to receive the stream of future payments and insurance risk factor data;
automatically calculating, by the computer processor of the present value calculation platform, a discount value, wherein reduction of the nominal value by the discount value results in a present value of the stream of future payments,
automatically calculating, by the computer processor of the present value calculation platform, a portion of the discount value to be allocated to the insured, and
transmitting an indication of the portion of the discount value to be allocated to the insured.

12. The method of claim 11, wherein the insured is an employer and the insurance policy is associated with a workers' compensation insurance policy.

13. The method of claim 12, wherein another party acts as a third party administrator of the workers' compensation insurance policy.

14. The method of claim 11, wherein the insurance risk factor data includes mortality data and the information about the party potentially entitled to receive the stream of future payments includes at least one of: (i) a date of birth, (ii) an age, and (iii) a gender.

15. The method of claim 11, wherein calculating the discount value includes associating a first part of the stream of future payments with a medical inflation rate and a second part of the stream of future payments with a cost of living inflation rate.

16. The method of claim 15, wherein the cost of living inflation rate is automatically determined based on a location of the stream of future payments.

17. The method of claim 11, wherein an insurance risk factor computer storage unit and the computer processor are associated with a computer executing a spreadsheet application template.

18. The method of clam 17, wherein the spreadsheet application template is constructed to include a claim projection portion, a male mortality portion, a female mortality portion, and a state-by-state inflation rate portion.

19. A system associated with an insurer, an insured, and a party potentially entitled to receive a stream of future payments in connection with an insurance policy, the system comprising:
an insurance risk factor computer storage unit for receiving, storing, and providing insurance risk factor data;
a processor in communication with the insurance risk factor computer storage unit, wherein the processor is configured for:
receiving information about the party,
automatically calculating a nominal value associated with the stream of future payments based at least in part on the information about the party and insurance risk factor data,
calculating a discount value, wherein reduction of the nominal value by the discount value results in a present value of the stream of future payments,
calculating a portion of the discount value to be allocated to the insured, and
transmitting an indication of the portion of the discount value to be allocated to the insured.

20. The system of claim 19, wherein another party acts as a third party administrator of the workers' compensation insurance policy.

21. The system of claim 20, wherein the insurance risk factor data includes mortality data and the information about the party potentially entitled to receive the stream of future payments includes at least one of: (i) a date of birth, (ii) an age, and (iii) a gender.

22. The system of claim 21, wherein calculating the discount value includes associating a first part of the stream of future payments with a medical inflation rate and a second part of the stream of future payments with a cost of living inflation rate, wherein the cost of living inflation rate is automatically determined based on a location of the stream of future payments.
